(19) United States
(12) Patent Application Publication
(10) Pub. No.: US 2012/0185951 A1
(43) Pub. Date: Jul. 19, 2012

(54) METHOD AND APPARATUS FOR MEDICAL INFORMATION ENCRYPTION

(75) Inventors: Aaron A. Bauman, Smithville, OH (US); Christopher M. Harley, Lakewood, OH (US); Alan J. Gilbert, Hudson, OH (US); Rem O. Siekmann, Mentor, OH (US); Glenn T. Burke, Cleveland Hts., OH (US)

(73) Assignee: CODONICS, INC., Middleburg Heights, OH (US)

(21) Appl. No.: 13/256,082

(22) PCT Filed: Mar. 11, 2010
(86) PCT No.: PCT/US10/26959

§ 371 Date: Apr. 6, 2012

Related U.S. Application Data
(60) Provisional application No. 61/159,278, filed on Mar. 11, 2009.
(60) Provisional application No. 61/161,217, filed on Mar. 18, 2009.

(51) Int. Cl. G06F 21/24; G06F 12/14

(52) U.S. Cl. 726/30

(57) ABSTRACT

Provided is an apparatus, system and method for protecting medical output to be stored on a portable computer-readable medium. Access to the medical output is restricted and a key is established to grant access to the medical output stored on the portable computer-readable medium. An identifier is assigned to the portable computer-readable medium and stored on both the portable computer-readable medium and a computer memory. The medical output is stored on the portable computer-readable memory, and access to the medical output on the portable computer-readable medium is restricted, requiring the key for accessing and viewing the medical output. The key is also stored in the computer memory and a relationship associating the identifier with the key is established to enable identification of the key with knowledge of the identifier. A security utility and a medical presentation utility can also be stored on the portable computer-readable medium. The security utility and medical presentation utility can be executable by the user computer to grant access to, and present the medical output on the portable computer-readable medium to the intended recipient in response to entry of the key.

### CROSS-REFERENCE TO RELATED APPLICATIONS

This application claims the benefit of U.S. Provisional Application No. 61/161,217, filed Mar. 18, 2009, and U.S. Provisional Application No. 61/159,278, filed Mar. 11, 2009, which are incorporated in their entirety herein by reference.

### BACKGROUND OF THE INVENTION

1. Field of the Invention

This application relates generally to a method and apparatus for securely publishing medical information relating to a patient onto a computer readable medium, and more specifically, to a method and apparatus for encrypting medical information of a patient on a portable computer readable medium, wherein the medical information can subsequently be decrypted and made accessible to a user from the computer readable medium by a password.

2. Description of Related Art

Traditionally when a patient visits a healthcare provider and undergoes an examination, the results of the examination are stored in a computer-accessible database maintained by the health care provider. Storing medical information in an electronic database minimizes the physical storage space required to maintain such records. Further, electronic medical records can optionally be recorded onto a portable computer readable medium such as a CD or DVD, for example, for archival purposes or to be given to the patient for his or her own medical records. Such discs can also be generated to convey medical information to a different healthcare provider that will conduct a follow-up examination or further analyze the results of the examination conducted by the healthcare provider that conducted the examination and created the disc.

Conventional discs storing medical information have traditionally lacked security features to safeguard the medical information stored thereon in the event the disc is lost, and comes into the possession of an unauthorized party that is not rightfully entitled to view the medical information. Thus, health care providers are reluctant to store private medical information onto such discs, and this reluctance can impede the necessary flow of such medical information as required to effectively treat the patient.

Accordingly, there is a need in the art for a method and apparatus for encrypted medical information on a portable computer readable medium and conveying a password for decrypting the medical information on the portable computer readable medium to a user. The method and apparatus can optionally include presenting the password on or with the portable computer readable medium itself without clearly identifying the password as such.

### BRIEF SUMMARY

According to one aspect, the subject application involves a method of protecting medical output to be stored on a portable computer-readable medium. The method includes using a computer operatively connected to a communication network to receive the medical output to be stored on the portable computer-readable medium over the communication network. Access to the medical output is restricted and a key is established. The key is to be entered by an intended recipient of the portable computer-readable medium into a user computer to which the portable computer-readable medium is provided to gain access to the medical output stored on the portable computer-readable medium. An identifier is assigned to the portable computer-readable medium and stored on both the portable computer-readable medium and a computer memory operatively connected to the computer. The medical output is stored on the portable computer-readable memory, and access to the medical output on the portable computer-readable medium is restricted, requiring the key to access and view the medical output. The key is also stored in the computer memory and a relationship associating the identifier with the key is established to enable identification of the key with knowledge of the identifier. A security utility and a medical presentation utility that is compatible with the medical output are also stored on the portable computer-readable medium. The security utility is executable by the user computer to grant access to the medical output on the portable computer-readable medium in response to entry of the key. The medical presentation utility is executable by the user computer to present the medical output to the intended recipient of the portable computer-readable medium subsequent to entry of the key into the security utility.

According to another aspect, the subject application involves a publisher for publishing a portable computer-readable medium storing encrypted medical output. The publisher includes a network interface for receiving the medical output over a communication network and a computer-accessible memory for at least temporarily storing the medical output received over the communication network. A recording bay is provided for receiving the portable computer-readable medium and writing the medical output to the portable computer-readable medium. A labeler creates label content to be associated with the portable computer-readable medium, and a processing component is provided for executing computer-executable instructions stored in the computer-executable memory for performing a method. The method performed includes restricting access to the medical output and establishing a key that is to be entered by an intended recipient of the portable computer-readable medium into a user computer to gain access to the medical output stored on the portable computer-readable medium. An identifier is assigned to the portable computer-readable medium and the identifier is stored on both the portable computer-readable medium and a computer memory operatively connected to the publisher. The medical output is stored on the portable computer-readable memory via the recording bay, and access to the medical output on the portable computer-readable medium is restricted, requiring the key to access and view the medical output. The key is stored in the computer memory and a relationship associating the identifier with the key is established to enable identification of the key with knowledge of the identifier. A security utility and a medical presentation utility that is compatible with the medical output are also stored on the portable computer-readable medium. The security utility is executable by the user computer to grant access to the medical output on the portable computer-readable medium in response to entry of the key and the medical presentation utility is executable by the user computer to present the medical output to the intended recipient of the portable computer-readable medium subsequent to entry of the key into the security utility.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of a portable computer readable medium publisher;

FIG. 2 shows a partially cutaway view of the portable computer readable medium publisher shown in FIG. 1;

FIG. 3 shows a block diagram of an embodiment of a portable computer readable medium publisher;

FIG. 4 shows an illustrative example of a medical output to be stored on a portable computer readable medium publisher;

FIG. 5 shows an illustrative example of a medical network for communicating medical output to a portable computer readable medium publisher;

FIG. 6 shows an illustrative example of a label including variable and fixed label content;

FIG. 7 shows an illustrative example of a window to be displayed to a user of a portable computer readable medium publisher to enable encryption of medical output to be stored on a portable computer readable medium;

FIG. 8 shows an illustrative example of a window to be displayed to a user attempting to gain access to encrypted medical output stored on a portable computer readable medium;

FIG. 9 shows an illustrative example of a progress window indicating progress of decryption of medical output from a portable computer readable medium; and

FIG. 10 shows an illustrative example of an information window informing the user that medical output is to be stored, at least temporarily onto a computer being used to gain access to encrypted medical output stored on a portable computer readable medium.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

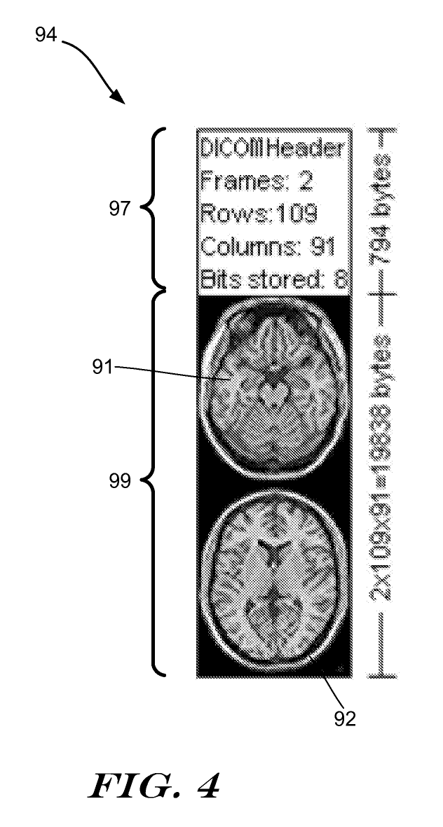

The subject application relates to a method and apparatus for storing a medical modality output (referred to herein as a “medical output”) representing an analysis of a human or other living patient that is formatted in a standard medical output format that can be stored on a portable computer-readable medium. The standard medical format can be any format in which the medical output (e.g., x-ray, MRI scan, electrocardiogram, etc . . . ) produced by a medical modality is commonly formatted, and that can be presented to a user via a user computer terminal provided with a compatible medical output viewer or other such media presentation software to reproduce or otherwise present the medical output to the user. Such media presentation software can optionally be stored on the portable computer-readable medium 12 along with the medical output, and can be executed by the user computer from the portable computer-readable medium 12. The medical output from any medical modality can be stored on a portable computer-readable medium 12 as described herein, however, for the sake of clarity and to particularly describe the present technology, an example of a medical output in the form of a medical image will be discussed herein. But it is to be understood that the output of a medical modality can include any image, audio track, data plot, graphical representation, motion picture, text report, and any other type of media file output by a medical modality, any medical-related information about a patient, or any combination thereof, is included within the scope of the technology described herein. Thus, references to a medical image 94 (FIG. 4) herein are equally applicable to the other types of medical output.

Examples of the medical output formatting standard include, but are not limited to, a format that is compliant with Part 10 (PS 3.10-2008) or any other part of the Digital Imaging and Communications in Medicine (“DICOM”) file format established by the National Electrical Manufacturers Association (“NEMA”), compliant with the Portable Data for Imaging (“PDI”) standards maintained by IHE International, or both for example. Publication of a portable computer-readable medium 12 includes at least one of storing the medical output produced by a medical modality onto the portable computer-readable medium 12 and applying label information within a label region on the portable computer-readable medium 12. Embodiments of the label information include, but are not limited to, human-readable information (i.e., visually readable by the human eye without first requiring conversion by a computer or other electronic reader), machine-readable information such as 2D and 3D bar codes, or any combination thereof

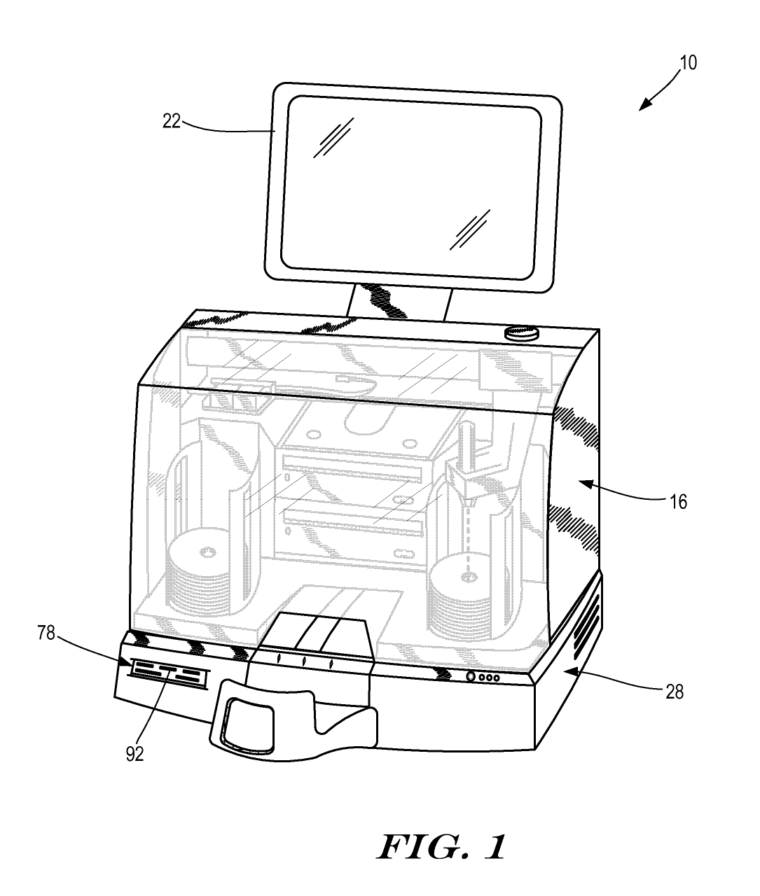

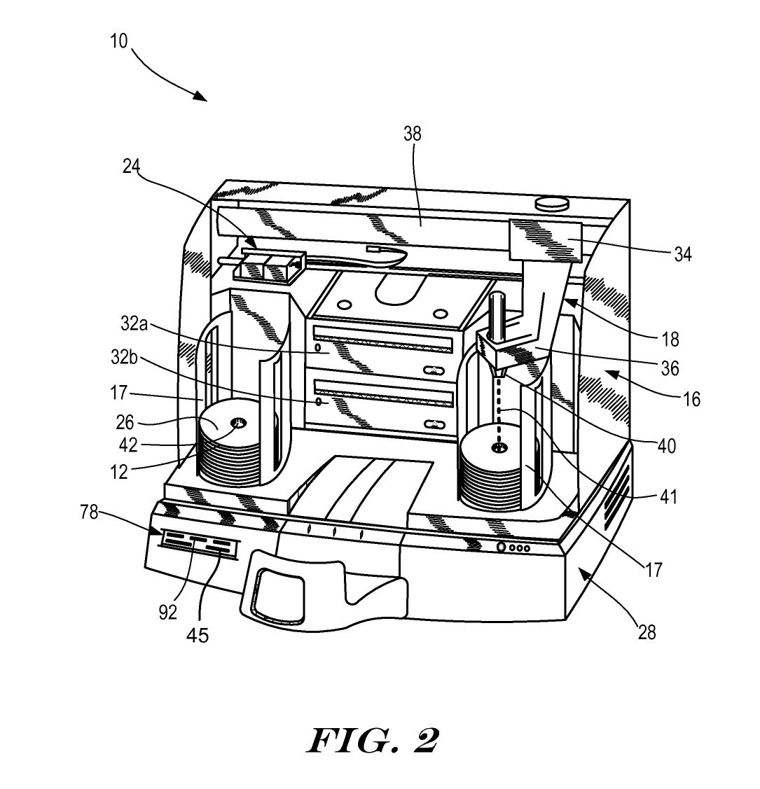

FIG. 1 shows an illustrative embodiment of a computer-readable-media publisher 10 in accordance with an embodiment of the present invention, an example of which is described in U.S. Patent Application Publication No. 2008/0122878 to Keefe et al., the entirety of which is incorporated herein by reference. Although such a publisher 10 can be utilized in any field in which it is desirable to record electronic data onto one or more portable computer readable media 12. Thus, the embodiments of the present invention are described below as being used in the medical field for the sake of clarity. Such embodiments are described herein as storing the medical image 94, or any other form of medical output onto the portable computer-readable medium 12 (FIG. 2), applying label information onto the portable computer-readable medium 12, or a combination thereof, resulting in publication of the portable computer-readable medium 12.

The process of publishing the portable computer-readable medium 12 can be arranged into “jobs”. Each job results in the publication of one or a plurality of portable computer-readable media 12 storing medical output that can optionally comprise one or more medical images or other forms of output produced by a medical modality. All medical output included in the job is to be stored on the portable computer-readable medium 12 according to one or more parameters in a parameter set, which is also referred to herein as a “job profile”. For example, the job profile can include a setting of the publisher 10 indicating a type of encryption to be performed by the publisher 10 on the medical output to be stored on the portable computer-readable medium 12. Other embodiments of the job profile include a setting indicating a suitable viewer (whether encrypted or unencrypted) to be stored on the portable computer-readable medium 12 in addition to the medical output, for example. Yet other embodiments of the job profile include a setting that can be read by the publisher 10 to determine the type (e.g., CD or DVD) of the portable computer-readable medium 12 to be used for storing the medical output.

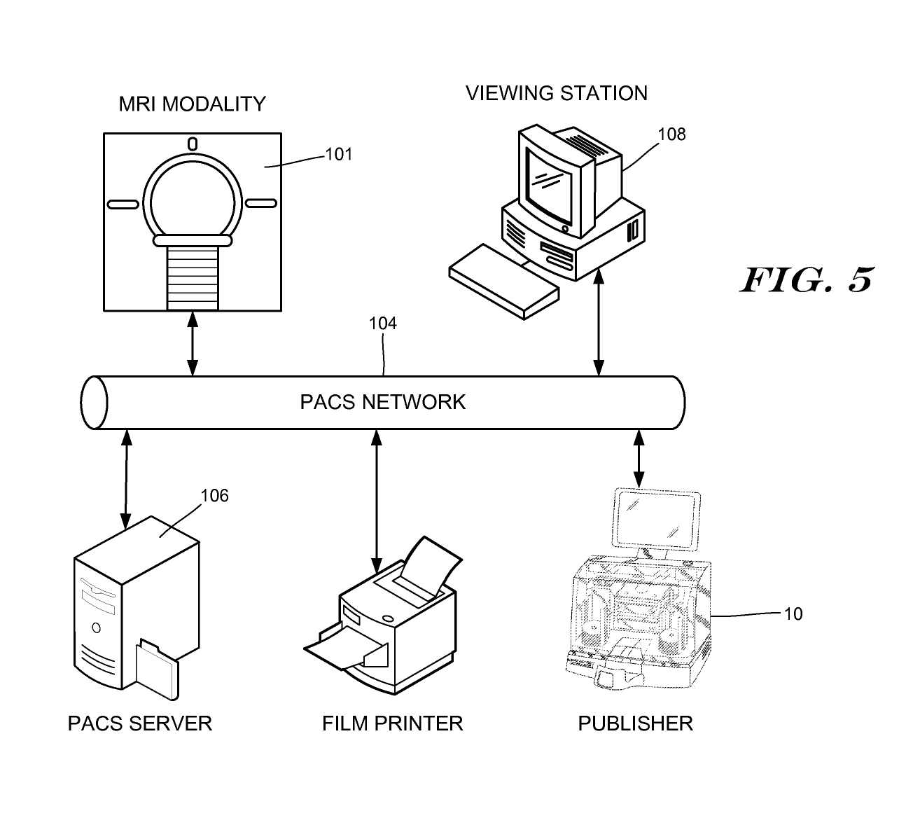

The job profile to be selected to govern each publication of a portable computer-readable medium 12 can optionally be selected automatically by the publisher 10 in response to receiving an identifier called an Application Entity Title (hereinafter “AE Title”). A relationship such as a lookup table, for example, can be stored in a non-volatile computer-accessible memory provided to the publisher 10, such as buffer memory 88a for example, to relate each AE Title to a corresponding job profile. Each medical modality, for example, can be assigned a predetermined AE Title, and when a job including medical output from that medical modality is sent to the publisher over a communication network 104 (FIG. 5) to be stored on a portable computer-readable medium 12, the publisher 10 can select the appropriate job profile for that job based on the AE Title of the medical modality that is received by the publisher 10 along with the medical output.

For the illustrative embodiments, the medical image 94 representing the medical output is not limited to electronic data representing only medical images, but also includes all associated charts, files, and the like. And as mentioned above, the medical output can optionally be formatted in compliance with Part 10 (PS 3.10-2008) or any other part of the DICOM standard established by the National Electrical Manufacturers Association (“NEMA”), in compliance with the PDI standards maintained by IHE International, or both, to be stored on the portable computer-readable medium 12. The medical images referred to herein are in electronic form, and can optionally be broken into separate electronic files to be recorded onto the portable computer-readable medium 12, and can be a document, image, audio file, video file, or any combination thereof, and other such files related to the medical image captured by a medical modality.

With continued reference to FIGS. 1 and 2, the publisher 10 records the electronic data onto the portable computer-readable medium 12 to be given to the end user, which can be the patient, another healthcare provider, or any other authorized end user who is an intended recipient of the medical output. A medical presentation utility such as a viewer or other suitable presentation software application (hereinafter “Viewer”) that is compatible with the format of the medical output and can be executed on a user computer to present the encrypted medical output, once the medical output has been decrypted, to the end user. According to alternate embodiments, the Viewer can optionally also be encrypted on the portable computer-readable medium 12 in addition to the medical output, requiring entry of a password or other suitable key to enable a user computer to grant a user access to the Viewer. Thus, an unauthorized user who inadvertently comes into possession of the portable computer-readable medium 12 would not be able to glean information about the medical output stored thereon based simply on the type of Viewer also present on the portable computer-readable medium 12. Further, the Viewer can optionally, when executed by a user computer in an effort to retrieve and present encrypted medical output, can automatically and without operator intervention execute a decryption utility in which a key can be entered to decrypt or otherwise unsecure the medical output as described herein. For such embodiments, the auto-executable decryption utility operates seamlessly with the decryption utility and can optionally be integrally included as a portion of the Viewer, or can be a separate utility executed by the Viewer in response to an attempt to present encrypted medical output.

The publisher 10 encrypts, locks, restricts access to, or otherwise secures access to the electronic data on the portable computer-readable medium 12 to limit access to the encrypted electronic data to authorized users. The authorized users can use a password or other suitable key to decrypt, unlock or otherwise gain access to the electronic data to be retrieved and displayed by the user computer. The authorized users can then view the electronic data from the portable computer-readable medium 12 and cause it to be displayed in a private setting such as the patient's home, or the radiologist's office, with a user computer executing the Viewer or other compatible medical presentation utility. Alternately, the authorized user can be a medical facility different from the facility that captured or otherwise created the medical image 94. This different facility can gain access to the encrypted electronic data on the portable computer-readable medium 12 via the password or other suitable key and import data from the portable computer-readable medium 12, including the medical images and patient information, to be entered into a network maintained by the different facility.

As shown in FIGS. 1 and 2, the publisher 10 comprises a recorder 16 including one or more recording bays 32a, 32b for recording the electronic data onto the portable computer-readable medium 12, and an automated feeder 18 that can be provided to the recorder 16 for transporting the portable computer-readable medium 12 from a storage bin 17 to the recording bays 32a, 32b without intervention by an operator once publication of the portable-computer readable medium 12 has been initiated. That is, once an instruction to publish a portable computer-readable medium 12 has been entered by an operator of the publisher 10 or another computer terminal operatively connected to communicate with a host computer as described in detail below, the automated feeder 18 can supply the computer-readable medium 12 retrieved from the storage bin 17 to the recorder 16 without further intervention by the operator. The application of label information and/or storing of the medical output onto the portable computer-readable medium 12 can also optionally be automated and performed without operator intervention. Although described above as including automated features such as the automated feeder 18, the publisher 10 can include one or more manually operable features, such as a manually-loadable recording bay without departing from the scope of the present invention.

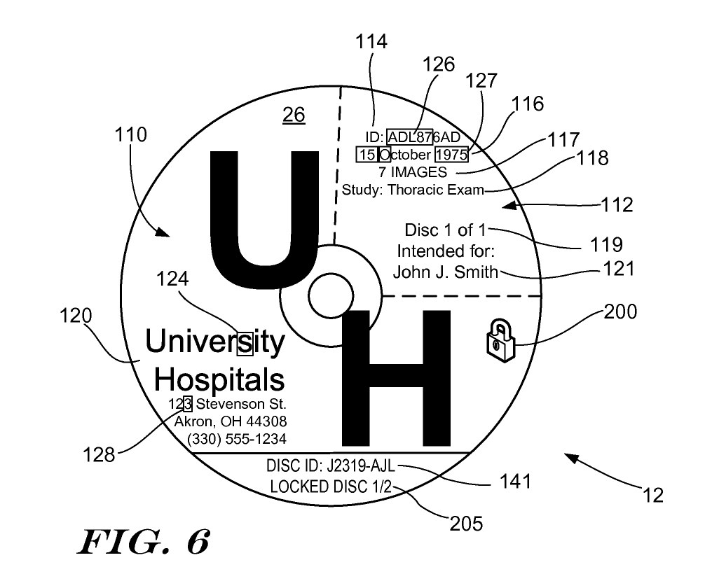

In addition to the recorder 16 and automated feeder 18, the publisher 10 further comprises a user interface 22 which, for some embodiments herein can be a touch-screen display panel, for example, presenting the operator with one or more options that the operator can select to enter a command for controlling operation of the publisher 10 as described in detail below. A printer 24 is provided for printing onto a surface of a label 26 at least variable label content 112 (FIG. 6) that is related to at least one of: the patient, the electronic data that can be retrieved from the portable computer-readable medium 12 and reviewed by the authorized end user, the intended recipient of the medical information stored on the portable computer-readable medium 12, the source of the portable computer-readable medium 12, or any combination thereof. Variable label content includes content to be printed onto the label 26 that can vary on a per-job basis, or a per-disc basis, for example. Other embodiments may also include fixed label content 110 that can optionally be pre-printed onto the label 26 before the disc is provided to the publisher 10, or printed by the printer 24 during publication, but does not necessarily change on a per job, or per disc basis. An example of fixed label content 110 can include a name, and/or logo of the health car provider, for example. Variable label content can optionally be printed on a label already bearing fixed label content, or both the variable label content and the fixed label content can optionally be printed by the publisher 10 on the label 26 to provide to recipients a visual indication that is indicative of the nature of the electronic data stored on the portable computer-readable medium 12. As mentioned above, the label information (i.e., the variable label content, the fixed label content, or a combination thereof) can include human-readable characters that can be input by a user via a computer keyboard and/or mouse or other input device, such as letters, numbers and symbols, for example, machine readable symbols such as bar codes, for example, or a combination thereof. By human readable, it is meant that the characters making up the label information are visually readable by the human eye without first requiring conversion by a computer or other electronic reader.

A microprocessor such as a multiple-core processor, for example, or other suitable central processing unit 80 provided to a control unit 28 (FIGS. 1, 2 and 3) executes computer-executable logic to carry out operations that control at least one of: the delivery of the medical image 94 to the one of the recording bays 32a, 32b to be stored onto the portable computer-readable medium 12; operation of the printer 24 for printing the label content onto the surface of the label 26; operation of the automated feeder 18; and coordination of these functions.

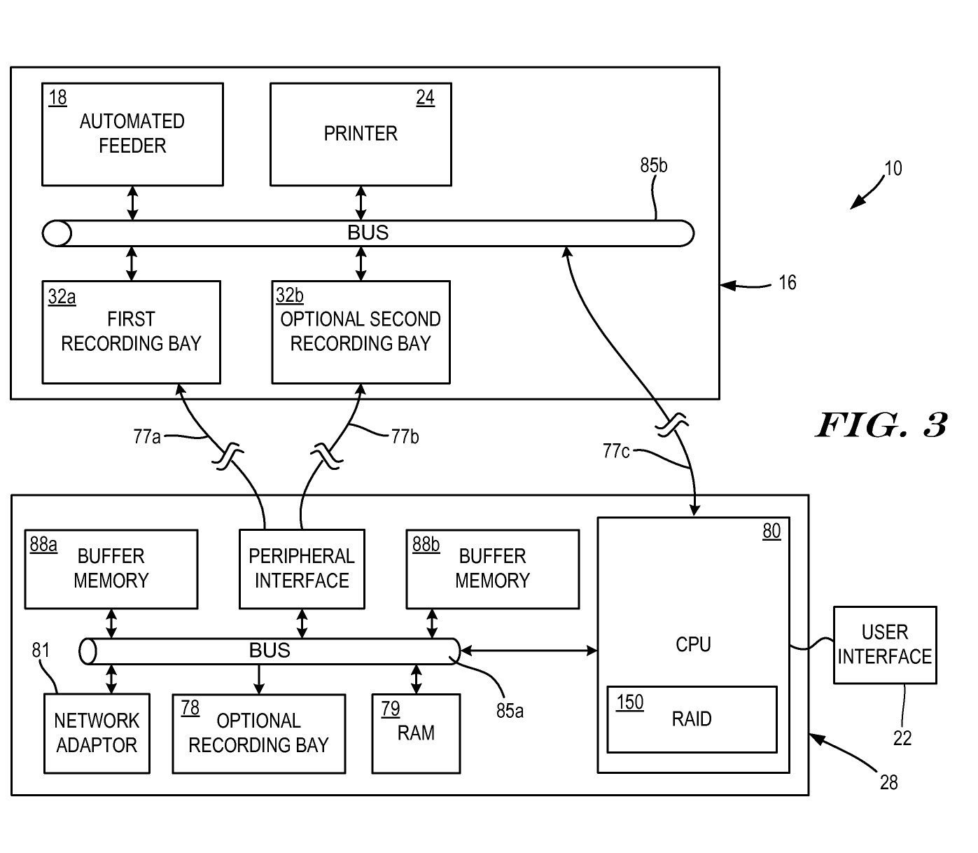

The control unit 28 also includes other conventional computer components such as a volatile operational memory such as random access memory (“RAM”) 79 (FIG. 3) for temporarily storing information during operation of the publisher 10. Further, a network interface 81, which can be a wireless network adaptor compliant with the IEEE 802.1x standards, for example, or any high-speed LAN connection such as a 10/100 Ethernet adaptor, for example, enables the publisher 10 to receive the medical image and other medical outputs over the communication network 104 (FIG. 5) from a host computer and/or a medical modality (shown as an MRI scanner 101 in FIG. 5) as discussed below. The host computer can be a medical output storage device such as a PACS server 106, a computer workstation 108 connected to the network 104, or any other computer storage device in communication with the network 104. The host computer can communicate via any conventional network communication protocol such as TCP/IP, for example, and can optionally be hardwired directly to the publisher 10 via a USB, Ethernet, Firewire, or any other suitable connector, or remotely located to communicate with the publisher 10 over the communication network 104. The communication network 104 (FIG. 5) can include the publisher 10 and, operatively connected to communicate with the publisher 10, at least one of a: computer database storing the medical output in compliance with the medical output formatting standard, a medical modality, and a medical workstation associated with a medical care provider. Bus systems 85a, 85b (FIG. 3) can be provided to the control unit 28 and the recorder 16 for transmitting signals between the various components of the control unit 28 and recorder 16. Communication can be established by independent communication channels 77a, 77b, 77c, which can be any suitable data carrier such as eSATA connections, for example. Computer-accessible memory such as buffer memories 88a, 88b can be provided in communication with the central processing unit 80, along with an optional RAID controller 150, for at least temporarily storing medical output to be subsequently stored on the portable computer-readable medium 12.

The portable computer-readable medium 12 is said to be portable in that it is a mass storage medium that can be used to store information according to a standard that enables the end user to retrieve and review the electronic data with computers other than the publisher 10 itself In other words, the portable computer-readable medium 12 can be a passive medium to be temporarily inserted into a compatible drive unit of a personal computer or other computer terminal for retrieving and reviewing the electronic data there from. Examples of suitable portable computer-readable media 12 include, but are not limited to, optical media such as a compact disc (also commonly referred to as a “CD”, “CD-ROM”, “CD+R”, “CD-R”, “CD-RW”—collectively referred to herein as “CD”); digital video disc (also commonly referred to as a “digital versatile disc,” and including “DVD”, “DVD-ROM”, “DVD-R”, “DVD-RW”, “DVD+R”, “DVD+RW”, “DVD-RAM”, and the like—collectively referred to herein as “DVD”); Blu-ray Discs such as BD-R, BD-RE, and the like—collectively referred to herein as “Blu-ray Disc”); HD-DVD; and the like. Another suitable portable computer-readable medium 12 includes a USB flash drive commonly referred to as a jump drive, USB drive or memory key that includes an EEPROM based memory integrated with a USB interface. According to other embodiments, the portable computer-readable medium 12 can include other types of media such as SD cards, compact flash cards, and the like.

According to the embodiment shown in FIGS. 2 and 3, the recorder 16 includes at least a first optical recording bay 32a, and optionally a second optical recording bay 32b (the one or more optical recording bays 32a, 32b collectively referred to herein as recording bays 32), adapted to record electronic data onto optical portable computer-readable media 12 to be given to the end user. The two optical recording bays 32a, 32b can both be CD writer drives, they can both be DVD writer drives, they can both be Blu-ray Disc writers, or any combination thereof. Further embodiments include either or both of the optical recording bays 32a, 32b in the form of a combined CD/DVD/Blu-ray writer drive capable of selectively storing the medical image 94 (FIG. 4) onto any of the respective optical formats. The CD, DVD and Blu-ray Disc writers record data onto a data storage side of a CD, DVD and Blu-ray disc, respectively, by impinging laser light from a laser source onto said data side. The laser light forms a pattern on the data storage side of the CD, DVD and/or Blu-ray Disc, optionally on a plurality of different layers of that medium, to thereby record the medical image 94 onto the CD, DVD and/or Blu-ray Disc.

The medical image in FIG. 4 is an example of a DICOM compliant medical output, which includes a DICOM header 97 embedded as part of the medical output. As shown, the medical image 94 is a magnetic resonance image (“MRI”) compliant with the DICOM standard. In this example, the first 794 bytes include information that is collectively referred to as a DICOM header 97, and the remainder of the medical output 94 comprises the image data 99. The example of a medical output shown in FIG. 4 includes a first image 91 and a second image 92, wherein the second image 92 displays a cross section of a human brain taken one level deeper than the cross section displayed by the first image 91. The information within the DICOM header 97 can vary depending on the type of the image within the medical output 94. A representative list of information and parameters to be defined in the DICOM header 97 is included in Part 3 (PS 3.3-2008) of the DICOM standard for various image types, such information to be included in the DICOM header 97 being incorporated in its entirety herein by reference. Examples of information commonly found in the DICOM header 97 include, but are not limited to: the modality used to capture the image appearing in the medical image 94; the image dimensions; the file size; the Transfer Syntax Unique Identifier (“UID”) indicating a type of compression used on the image data 99, if any; the byte order of the image data 99; MRI echo time, the samples per pixel, photometric interpretation, and bits allocated, for example. To minimize the likelihood of the DICOM header 97 getting separated from the image data 99 both the DICOM header 97 and the image data are integrally combined to form the medical image 94 that is compliant with the DICOM standard.

In addition to, or instead of one or both of the two optical recording bays 32a, 32b in FIG. 2, the recorder 16 can suitably be provided with any number of recording bays 32a, 32b, and optionally a recording bay 78 for recording the medical image 94 onto a portable computer-readable medium other than a CD and DVD. For example, a USB port 192 of the recording bay 78 allows a USB flash drive, external USB hard drive, and the like to be operatively connected to the publisher 10 for storing the medical image 94 thereon. The recording bay 78 can also optionally include additional format ports such as a SD card port 45 and the like, offering yet other alternatives to the optical format portable computer-readable medium 12. For the sake of brevity, however, the method and apparatus are described below as storing a medical image 94 onto an optical portable computer-readable medium 12.

For the embodiments that store medical images 94 onto optical computer-readable media 12, the automated feeder 18 of the publisher 10 retrieves a proper computer-readable medium 12 for storing a particular medical image 94 from a supply bin 17. The portable computer-readable medium 12 retrieved is inserted into one of the recording bays 32a, 32b from where the electronic data representing the medical output can be recorded. Each supply bin 17 can be an open column approximating the diameter of an optical computer-readable medium 12 that is defined by one or more plastic partitions. The automated feeder 18 can include any device that can be computer controlled, and autonomously-driven according to the execution of computer-executable logic. For example, a suitable automated feeder 18 can include a robotic arm 36 that can be positioned at a plurality of locations along a track 38. According to such embodiments, a drive motor 34 is activated according to the instructions from the computer-executable logic executed by the control unit 28 to adjust the position of an outwardly extending arm 36 along a transverse track 38. The automated feeder 18 can be operatively connected to communicate with the central processing unit 80 (FIG. 3) to receive control commands from the control unit 28 over the dedicated control signal path 77c. The arm 36 can be positioned to travel over the two supply bins 17 storing the optical portable computer-readable media 12 such that a medium grasping tool 40 is generally aligned with a central axis 41 of an aperture 42 formed in each portable computer-readable medium 12. Once properly aligned, the grasping tool 40 can be lowered into the bin 17 and into the aperture 42 of the portable computer-readable medium 12 to be inserted into one of the recording bays 32a, 32b. A diameter of the grasping tool 40 can be enlarged once inside the aperture 42 to secure the portable computer-readable medium 12 to the feeder 18.

With the portable computer-readable medium 12 secured to the feeder 18, the grasping tool 40 along with the portable computer-readable medium 12 is elevated out of the storage bin 17. The position of the arm 36 is then adjusted along the transverse track 38 toward the first or second recording bay 32a, 32b into which the portable computer-readable medium 12 is to be inserted. A door of the recording bays 32a, 32b can be opened to allow a supporting tray, such as the tray that can be extended out of a conventional CD/DVD/Blu-ray Disc writer for example, to be extended out of the recording bays 32a, 32b for receiving the portable computer-readable medium 12 in a manner known in the art. Once the portable computer-readable medium 12 is supported above the extended supporting tray, the diameter of the grasping tool 40 can be reduced to allow the aperture 42 of the portable computer-readable medium 12 to pass over the grasping tool 40, causing the portable computer-readable medium 12 to fall from the grasping tool 40 and into one of the recording bays 32a, 32b. This results in the portable computer-readable medium 12 falling onto the supporting tray, which is then retracted back into the recording bays 32a, 32b. Once the optical computer-readable medium 12 is disposed within one of the recording bays 32a, 32b, it is to be spun from its initial stationary state to a suitable angular velocity to achieve a desired write speed as part of a “spin-up” phase. Upon reaching the suitable angular velocity, the portion located a given radial distance from the center of the CD/DVD/Blu-ray Disc/HD-DVD, etc . . . at which the medical output is to be written rotates at a known velocity relative to a laser that is used to write the medical output onto the optical computer-readable medium 12, and thus, writing of the medical output at a desired speed can be controlled. During the initial stages of the spin-up phase, the control unit 28 also initiates interrogation of the computer-readable medium 12 in one of the recording bays 32a, 32b with the laser to determine the type (e.g., CD, DVD or Blu-ray Disc) that is present. Based on this interrogation the control unit 28 can execute the proper computer-executable logic for controlling the storage of the medical image 94 onto the type of the optical computer-readable medium 12 that is detected.

FIG. 6 shows an illustrative example of a portable computer-readable medium 12 including a label 26 (FIG. 2) on which label information is provided. The label information according to the present embodiment includes both fixed label content 110 and variable label content 112. The fixed label content 110 in FIG. 6 includes the name and address 120 of the health care provider that, according to the present embodiment, is the healthcare provider that collected the medical information and stored it onto the portable computer-readable medium 12 with the publisher 10. The variable label content in the present embodiment includes the patient's ID number 114, the patient's date of birth 116, the number of images stored 117, nature of the stored medical information 118, number of discs (order in series and total number) 119, and physician 121 to whom the portable computer-readable medium 12 is to be sent for review. However, the variable label content 112 can include any information specific to the contents of the portable computer-readable medium 12.

The label 26 shown in FIG. 6 also includes visual indicia indicating that electronic data, or at least a portion thereof, stored on the portable computer-readable medium 12 has been encrypted. If the end user of the portable computer-readable medium 12 experiences any difficulties gaining access to the medical output, that end user may contact the medical care provider, for example, that published the portable computer-readable medium 12. In rendering assistance to the end user, the medical care provider can ask the end user to look for such visual indicia so that the medical care provider can explain that a password or other decryption tool is required to gain access to the medical output on the portable computer-readable medium 12. For the embodiment shown in FIG. 6, a graphical lock symbol 200 along with text such as “LOCKED DISC ½” 205 appear on the label 26 to indicate that medical output on the portable computer-readable medium 12 is encrypted, requiring a password to view. Different indicia can optionally be used to indicate different methods of encryption used and/or different password methodologies employed. For example, a padlock could illustrate that 7Zip was used to encrypt the medical output on the portable computer-readable medium 12, and a safe could indicate that TrueCrypt® was used for the encryption. According to other embodiments, a number, letter or other symbol could also be included in the visual indicia to indicate to an authorized recipient of the portable computer-readable medium 12 how to determine the password. For example, a predetermined character and/or symbol can be displayed to indicate that the DOB was used for the password, and the recipient informed of this character and/or symbol. Another, different number, letter or symbol could then be used to indicate that Patient ID 114 was used instead.

According to alternate embodiments, the portable computer-readable medium 12 can optionally store medical output for a plurality of different patients. According to such embodiments the variable label content 112 can include the variable label content specific to one of the plurality of different patients, in addition to content indicating that the portable computer-readable medium 12 stores medical output pertaining to more than just a single patient.

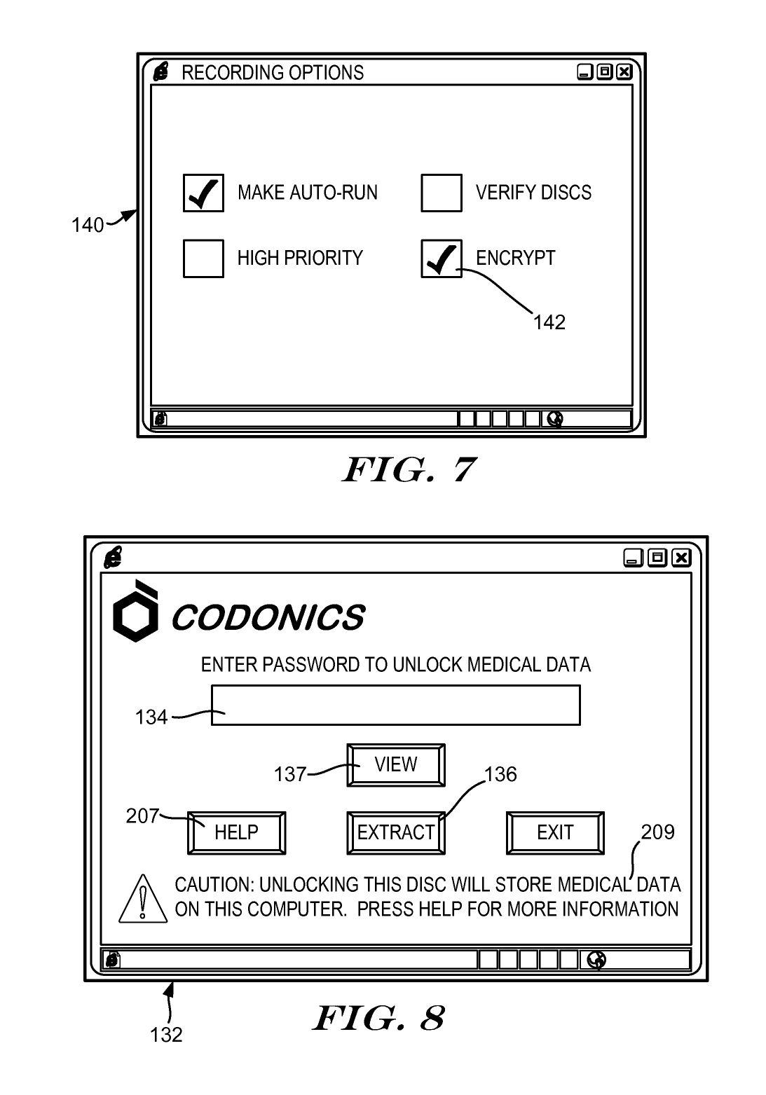

The publisher 10 can include an encryption feature that is to be activated by an administrator via a window 140 displayed by a user interface 22 as shown in FIG. 7 to publish a portable computer-readable medium 12 with encryption. Placing a check in the check box 142 can enable the encryption feature for password protecting the medical output on the portable computer-readable medium 12. For example, the publisher 10 can include a USB port 192 (FIGS. 1 and 2) that is accessible at the front panel of the publisher 10. A key to unlock and activate the encryption feature of the publisher 10 can be retrieved from a USB drive storing the key that is inserted into the USB port 192. Once the encryption feature has been activated it can remain so, even after the USB drive has been removed, until the administrator deactivates it. Further, data on the USB drive can optionally also include parameters for encryption such as criteria to be used for generating a password for securing the medical output on the portable computer-readable medium 12. Storing the configuration for encryption on the USB drive can allow the USB drive to be installed on various publishers 10 maintained on behalf of a given medical provider to promote uniformity. Updates to the settings such as those in the job profile for controlling operation of the publisher 10 in publishing the portable computer-readable medium 12 can optionally be accomplished by inserting the USB drive with the desired settings into the USB port 192.

The window 140 is presented to a user of the publisher 10 who is manually creating a job to store medical output onto the portable computer-readable medium 12. Other embodiments of the publisher 10 can optionally automatically determine whether encryption is to be employed, the type of encryption for the job, any other parameters regarding encryption, or any combination thereof based on the job profile selected in response to receiving the AE Title as explained above, based on a default setting of the publisher 10, or based on an encryption setting imported from the USB drive or other computer-accessible memory, for example.

For such automatic embodiments, the publisher 10 can automatically determine the password or other key code according to the job profile corresponding to the active setting for each publication of a portable computer-readable medium 12. The job profile can optionally define a collection of characters included in the information to be stored on the portable computer-readable medium 12, or optionally a collection of characters that are to appear on the label 26 of the portable computer-readable medium 12 to be combined in a predetermined sequence to form the password as described herein. The password can optionally be compiled from information about the patient, the healthcare provider, intended recipient of the portable computer-readable medium 12, or any combination thereof. When a publication process is initiated according to such embodiments, the appropriate encryption can be automatically performed by the publisher 10 without further input from the user who initiated the publication process. Such encryption can be performed in the background without alerting the user who initiated the publication process that encryption is to be performed.

The publisher 10 can optionally present the user with a user interface that allows the user of the publisher 10 to manually select a desired type of encryption such as 7Zip, TrueCrypt, or any other supported type of encryption scheme. For example, upon selecting the “Encrypt” check box 142 in FIG. 7, the option to manually select one or more types of encryption and possibly other settings governing encryption of the medical output can be displayed by a separate window (not shown) or in an expanded portion of the window 140 that is expanded in response to the selection of the “Encrypt” check box 142. Upon selecting the “Encrypt” check box 142 the user can be presented with an interface with a text entry field in which the user publishing the portable computer-readable medium 12 can manually input via key entry, or other suitable entry method, the desired password that is to be subsequently used to gain access to the medical output on the portable computer readable medium 12. Such passwords can include any combination including one or more alphabetic characters, numeric characters, symbols, or any other characters that can be entered via the peripheral interfaces provided to the publisher 10. According to alternate embodiments, the option to manually select one or more types of encryption and possibly other settings governing encryption of the medical output can be presented to the user of the publisher 10 in response to a determination that a conflict exists between the medical output and other data to be encrypted and the specific type of encryption selected, whether by default, by selection, or specified by the job profile. For example, some Viewers may not be compatible with all available types of encryption available to be performed by the publisher 10. If an encryption scheme that is incompatible with a Viewer that is to be encrypted on the portable computer-readable medium 12 is selected, then a window presenting the user of the publisher 10 with an option to rectify the conflict can be presented to the user. For instance, the window can present the user with the option to manually select a different encryption scheme, or the option to store the Viewer on the portable computer-readable medium 12 in an unencrypted state. According to alternate embodiments, the publisher 10 can automatically eliminate the Viewer from the electronic data to be encrypted and saved on the portable computer-readable medium 12, and optionally add the Viewer giving rise to the conflict to the portable computer-readable medium 12 in an unencrypted format, or excluding the Viewer from the portable computer-readable medium 12 altogether.

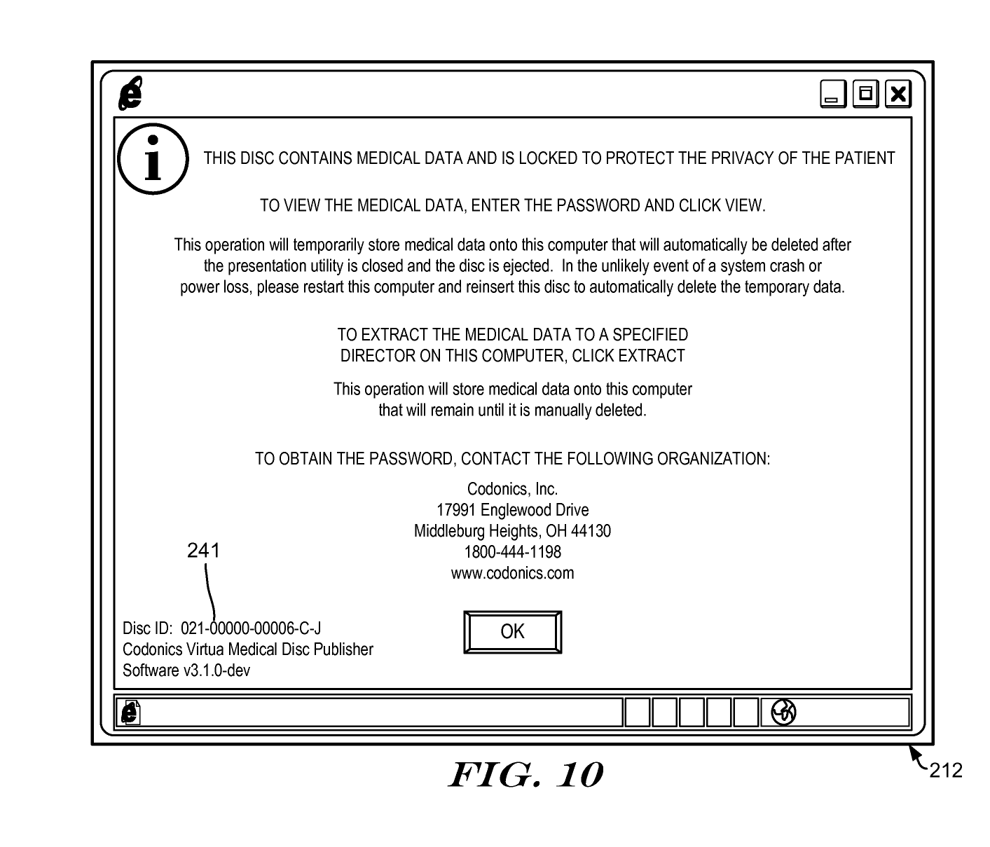

An unencrypted “Readme” text file can optionally be stored on the portable computer-readable medium 12 with the encrypted medical output. Thus, encryption can be performed to restrict access to the contents of the portable computer-readable medium 12 as a whole, or can be selectively performed as desired by the user on a per-file basis to encrypt a portion of the electronic data, but less than all, stored on the portable computer-readable medium 12. The text file can be opened and displayed by any computer terminal without restriction. The text file can include information about the patient, the medical output stored on the portable computer-readable medium 12, the party who the recipient of the portable computer-readable medium 12 can contact to resolve problems gaining access to encrypted medical output on the portable computer-readable medium 12, any other information not of a medically sensitive nature or required to be maintained in confidence, or any combination thereof. For example, the text file can include the disc ID 241 as shown in FIG. 10, as a backup in case the disc ID 141 on the label 26 shown in FIG. 6 becomes illegible. The unencrypted text file can also include contact information that the recipient can use to contact a party such as the medical care provider that published the portable computer-readable medium 12, for example, that can assist the recipient in recovering the password to gain access to encrypted medical output stored on the portable computer-readable medium 12. According to alternate embodiments, the unencrypted text file can optionally include the password, labeled as such, to allow a user to gain access to encrypted medical output on the portable computer readable medium 12 should the user forget, lose, or otherwise not have access to the password. Yet alternate embodiments of the unencrypted text file can include an obfuscated password that can be gleaned from a contiguous string or a combination of separated text characters, symbols, and the like stored in the unencrypted text file in a manner similar to that described herein for obfuscating the password within variable label content 112, fixed label content 110, or a combination thereof appearing on the label 26. For example, the password can be obtained by combining alpha-numeric characters from a word, date, ID number or other string appearing in the unencrypted text file in a manner known by or told to the user authorized to view or otherwise be presented with the medical output. The collection of characters can be selected by an operator of the publisher 10 used to publish the portable computer-readable medium 12, can be randomly selected by a random password generator component implemented by the publisher 10 executing computer-executable instructions and stored in a computer-accessible database, and the like.

The password, regardless of how it is established, can be stored in the database in a computer memory such as the hard disk drive provided to the publisher 10 or other network-connected memory, for example, in association with an identifier that can uniquely identify the portable computer-readable medium 12. The computer memory can be accessible to a provider of the portable computer-readable medium 12 or optionally an affiliated entity with administrative permissions. However, the computer memory can optionally be made inaccessible to users without authorization to gain access to passwords used to secure a portable computer-readable medium 12 delivered to someone other than the user. According to alternate embodiments, the computer memory can provided limited access to a restricted portion of information stored thereon. For instance, a user can enter and submit information identifying a portable computer-readable medium 12 in the user's possession into a website. A query can be performed by a server or other network-connected computer to retrieve the password corresponding to the submitted information and return the password to the user.

The password can be stored in an electronic spreadsheet, database or other suitable data storage utility in the computer memory in a row or column corresponding to the disc ID 241 (FIG. 10) of the portable computer-readable medium 12 delivered to the intended recipient. The password can optionally not accompany the portable computer-readable medium 12, or at least not be delivered in a fixed medium of expression and labeled as the password with the portable computer-readable medium when the portable computer-readable medium 12 is delivered to the intended recipient. Content delivered in a fixed medium of expression, as used herein, includes expressly-labeled printed characters that are readable by the human eye without machine or computer assistance. In other words, the password can optionally appear on the label, in an electronic file on the portable computer-readable medium 12, on a document accompanying the portable computer-readable medium 12, or any combination thereof, in another capacity such as the disc ID 241 or patient date of birth, but it is not identified as the password thereon. For example, the password does not expressly appear, as a whole, identified as such on the label, or stored on the portable computer-readable medium 12 in an electronic format expressly identified as the password on the portable computer-readable medium 12. The password can optionally be omitted from the label altogether and otherwise absent from all documentation delivered to the intended recipient along with the portable computer-readable medium 12. To obtain the password, the user can use contact information of a party with access to the database that is included with the portable computer-readable medium 12, such as on the label, stored on the portable computer-readable medium 12, or both. The user can provide the identifier such as the disc ID 141 or 241 number or other suitable identifier, optionally along with personal information or other security check to ensure that it is truly the intended recipient who is attempting to obtain the password. The party contacted via the contact information can provide the user with the password verbally, via email, via confirmation letter, or any other suitable communication channel in response to validating the identity of the user.

According to alternate embodiments, the password for gaining access to the medical output can be stored on the portable computer-readable medium 12, provided on the label as a contiguous string of characters, or a combination thereof, but not expressly identified as the password. For instance, the password can be the Disc ID 141 or 241, the patient's last name, or any other combination of characters stored on the portable computer-readable medium 12.

The encryption feature provided to the publisher 10 can allow the administrator to specify at least one of: how to deliver a password to the intended recipient, how to generate the password required to grant authorized users access to medical output on the portable computer readable medium 12, how the password or other type of key will be changed, how frequently the password is to be changed, or a combination thereof. For example, instead of, or in addition to providing the password on the portable computer readable medium 12 itself or another object such as a disk holder for storing the portable computer readable medium 12, the password can optionally be e-mailed from an e-mail component of the publisher 10 to an e-mail address associated with the authorized user who is to receive the portable computer readable medium 12, technical support personnel associated with the medical care provider that published the portable computer-readable medium 12, or any other desired party. The e-mail component is operatively connected to the network adaptor of the publisher 10 to transmit such electronic communications over the communication network to the intended recipient. The e-mail address can optionally be stored in a contact database in communication with the publisher 10 such that the email can be generated and transmitted automatically in response to publication of the portable computer-readable medium 12. Other embodiments of the publisher 10 include a mailing component that is operable to transmit the key and optionally the identifier to a workstation or printer, for example, to generate a printed letter, postcard, etc . . . to be mailed to the intended recipient. The password needed to access medical output stored on the portable computer readable medium 12 is to be included on an automatically-generated printed letter, postcard or other physical communication medium and transported via postal courier to the authorized user who is to receive the portable computer readable medium 12. The mailing component of the publisher 10 can optionally retrieve contact information such as an address for the intended recipient and transmit such retrieved information to the printer to address the communications to be delivered to the intended recipient. According to alternate embodiments, an identifier such as the disc ID 241 that can identify the portable computer-readable medium 12 delivered to the authorized user can also optionally be identified in the e-mail or physical communication. The identification of the identifier can be explicit as in the statement “The identifier is: XYZ.” According to alternate embodiments, the identification of the identifier can be indirect and based on information that is known to the authorized user but is not generally known to others and does not accompany the portable computer-readable medium 12. For instance, statements such as “The identifier is: the patient's birth year” and “The identifier is: the patient's social security number” and “The identifier is: the first name of the patient's primary care physician” are examples of such an indirect identification of the identifier if the patient's birth year, social security number and primary-care physician do not accompany the portable computer-readable medium 12 when delivered to the authorized user.

According to such embodiments, the publisher 10 does not need to generate a cryptic password based on at least one of variable label content 112, fixed label content 110, or a combination thereof. Instead, the publisher 10 can be configured to automatically, upon publication of the portable computer readable medium 12, generate a letter listing the password to be transported via postal courier to the authorized user of the portable computer readable medium 12. Alternately, the publisher 10 can automatically generate an e-mail addressed to the authorized user of a portable computer readable medium 12 to be transmitted over a communication network such as the Internet upon publication of the portable computer readable medium 12. The password transmitted via the letter or e-mail can be assigned in any conventional manner, can be selected from a list of passwords, can be randomly generated, can be the same password as another portable computer-readable medium 12, and can be clearly labeled as the password in the letter or e-mail but omitted altogether from the label 26. According to other embodiments the password can be automatically generated based on any DICOM data (i.e., data associated with the medical output according to the DICOM standard). Examples of the DICOM data include data extracted from the DICOM header 97 (FIG. 4), patient data of birth, any other data required according to the DICOM standard, or any combination thereof. Thus, if the portable computer-readable medium 12 fell into the possession of an unauthorized party, that unauthorized party could not open the encrypted medical output without the password, which would have been delivered separately from portable computer-readable medium 12 such as by courier or email for example.

According to an alternate embodiment, the publisher 10 can be configured to generate a password based at least in part on the variable label content 112, fixed label content 110, or a combination thereof. That password can appear on the label 26 in an obfuscated manner (i.e., not expressly identified on the label as the password, but capable of being determined based on information on the label 26 by an authorized party with knowledge of the manner of determining the password) and be subsequently discerned by an authorized user from the variable and/or fixed label content 112, 110 and entered into a user computer to gain access to the medical output stored on the portable computer readable medium 12. For such embodiments, the password can be discerned from the label 26 provided to the portable computer readable medium 12 itself, thus assuring an authorized user has the ability to discern the password from the label 26 to obtain the password as long as the authorized user has possession of the portable computer readable medium 12 and the label is readable. Discerning the obfuscated password from characters and information in the unencrypted text file on the portable computer readable medium 12 mentioned above is analogous to discerning the obfuscated password from characters appearing on the label 26 described with reference to FIG. 6.

With reference to FIG. 6, a plurality of characters, such as ASCII characters for example, are enclosed within rectangles, such as the rectangle 124 highlighting the letter “s” in the word University that is included in the fixed label content 110. The rectangles shown in FIG. 6 do not appear on the actual portable computer readable medium 12, but are merely shown in FIG. 6 for illustration purposes. The rectangles are shown in FIG. 6 simply to identify the characters on the label 26 from which a password was generated, and distinguish those characters from other characters on the label 26 that are not included in the password. One example of generating a password based at least in part on the variable label content 112, fixed label content 110, or a combination thereof, includes using the first five characters appearing in the patient's ID number 114 (designated by rectangle 126). Another example would be to combine the first five characters appearing in the patient's ID number 114 with the year in which the patient was born (designated by rectangle 127). Yet another example would be to generate the password to include at least the first five digits of the patient ID number 114 in combination with the year in which the patient was born, concluded by the third digit (designated by rectangle 128) in the health-care provider's address, which is the number three in the present example and is included in fixed label content 110.

In each of the above examples, the password required to gain access to the medical output on the portable computer-readable medium 12 can be discerned from information appearing on the label 26 of the portable computer readable medium 12 without expressly identifying it as such on the label 26. When the authorized user is given the portable computer readable medium 12, the healthcare provider can also at that time convey the manner in which the password can be discerned. Such a conveyance can occur verbally, for example. According to alternate embodiments a separate instruction indicating how to discern the password from the label 26 can be provided to the authorized user via a separate letter transported via postal courier or e-mail as described above. Those who come into possession of the portable computer readable medium 12 (and are not rightfully supposed or intended to view the medical output) will not be able to gain access to the encrypted medical output stored thereon simply by placing a portable computer readable medium 12 in any personal computer and opening the medical output as if it was not encrypted.

According to alternate embodiments, the publisher 10 can be configured to use a randomly-selected combination of characters from the label 26 as the password. This random combination can be one of a plurality of predetermined combinations, or can change for each portable computer readable medium 12 according to output from a random number generator implemented with the publisher 10. Regardless of the manner in which the password is generated, however, the publisher 10 can maintain, or transmit to be saved in a remotely stored electronic database, a log storing a list of portable computer readable media 12 published by the publisher 10 along with each of their passwords. For example, each portable computer-readable medium 12 can be represented in the log by the disc ID 141 appearing on the label 26 as shown in FIG. 6. The entry in the log including the disc ID 141 can also include other information relating to the portable computer-readable medium 12, such as the password, patient ID number 114, patient name, patient date of birth 116, or any other desired information relating to the portable computer-readable medium 12, or any combination thereof. The log can optionally be searchable to facilitate recovery of information stored therein. Thus, for embodiments where the password is randomly generated, at least the manner in which the authorized user receiving the portable computer readable medium 12 can determine the password from the label 26 can be conveyed to the authorized user over the phone during a customer service call for example.

For example, consider a first portable computer readable medium 12 published with medical output that is encrypted, and must be decrypted with a password comprising the first five digits of the patient ID 114 in combination with the patient's year of birth before the medical output can be displayed. Likewise a second portable computer readable medium 12 can be published, encrypting or otherwise securing the medical output using a password including the day on which the patient was born in combination with the patient's year of birth. In both instances, the healthcare provider can provide each authorized user with the manner in which they can discern their respective password from information contained in the label 26.

According to other embodiments, the password required to view medical output stored on a portable computer readable medium 12 can be specific to a particular authorized end-user or intended recipient. For example, a portable computer readable medium 12 to be delivered to a particular physician or healthcare provider for review can optionally require a password created from the first five characters of the patient ID 114 listed on the label 26 to gain access to the medical output secured with the password. Each of a plurality of different portable computer-readable media 12 for the common intended recipient can optionally store medical output encrypted in this manner, such as by utilizing a plurality of characters from the intended recipient's name as the password. Just as before, the particular physician or healthcare provider who is authorized to view the medical output will be informed of the manner in which the password can be determined from information appearing on the label 26. Accordingly, authorized users in possession of the portable computer readable medium 12 can discern the password required to view the medical output stored thereon while unauthorized individuals will be unlikely to determine the password.

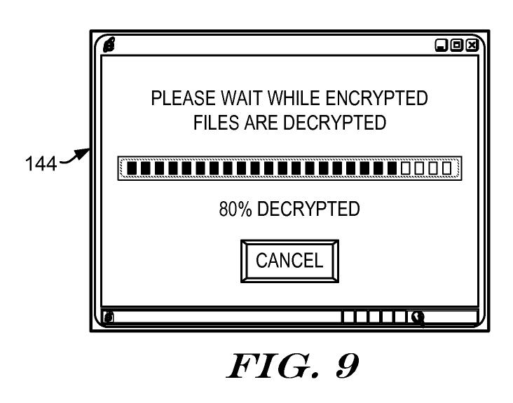

For a computer readable medium 12 storing encrypted medical output, a decryption or other suitable security utility can also be included on the portable computer readable medium 12. The decryption utility includes computer executable instructions that, when executed, prompt the user for the password. In response to receiving the correct password the decryption utility unlocks the encrypted medical output to be viewed by the user. The decryption utility can be launched on the computer being used to view the medical output automatically in response to receiving a request to open encrypted medical output. Portions of the decryption utility, including the medical output being decrypted can optionally be temporarily stored on the computer, depending on the decryption utility and encryption performed on the medical output. Upon being executed, the decryption utility causes a window such as that shown in FIG. 8 to be displayed to the user. The window 132 includes a text entry field 134 in which the user is prompted to enter a password. After entering the password the user can select between an “Extract” button 136 and a “View” button 137. Both buttons 136, 137 submit the password entered by the user in the text entry field 134 for comparison with the actual password used to encrypt or otherwise secure the medical output on the portable computer readable medium 12. Selecting the Extract button 136 begins the process of decrypting the medical output stored on the portable computer readable medium 12 and copying it, at least temporarily, onto a computer-accessible memory in communication with the computer being used to read portable computer readable medium 12. If the Extract button 136 is selected, a window (not shown) including an option to select a location on the computer-accessible memory at which the decrypted medical output can be stored can be presented to the user. In turn, the user can select a desired location on the computer-accessible memory and initiate extraction and non-volatile storage of the decrypted medical output to that location. If the password entered by the user matches the actual password, a progress window 144 such as that shown in FIG. 9 can be displayed indicating that the password was successfully validated and that the encrypted medical output is being decrypted. Once storage of the decrypted medical output is complete the user can subsequently retrieve the decrypted medical output to be viewed by the computer from the location at which the decrypted medical output was stored.

According to alternate embodiments, the decryption utility can form an integrated portion of the Viewer. In other words, if an attempt is made to open the medical output from the portable computer-readable medium 12 with the Viewer, the Viewer can optionally automatically launch the decryption utility portion to display the window 132 in FIG. 8, for example, or other suitable user interface prompting the user to enter the password. If the correct password is entered the medical output attempting to be viewed can then be decrypted as that medical output is being retrieved to be presented to the user by the Viewer. The medical output that the user is attempting to gain access to can be decrypted in this manner and presented to the user via the Viewer, allowing the remaining encrypted content on the portable computer-readable medium 12 to be maintained in its encrypted state. Opening the medical output in this manner can also result in presenting to the user the option to save decrypted medical output onto a non-volatile computer-accessible memory.

Referring once again to the embodiment in FIG. 8, if the user selects the View button 137 and the password entered by the user matches the actual password, the decryption and reading of the medical output from the portable computer readable medium 12 to be viewed can begin. Unlike the response to selection of the Extract button 136, when the user selects the View button 137 the decrypted medical output can be temporarily stored at a temporary location on the computer-accessible memory and displayed by the computer. The decrypted medical output can optionally be automatically deleted from the temporary location by the computer executing computer-executable instructions, such as the decryption utility for example, in response to closing of the Viewer, removal of the portable computer-readable medium 12 from the computer used to view the medical output, or a combination thereof. In the event operation of the computer is interrupted, such as occurs during a loss of power or power spike/drop, or if the computer is unintentionally turned off for example, the medical output temporarily stored on the computer can be deleted from the temporary storage location by the decryption utility when operation of the computer resumes. Thus, if such an interruption event occurs and the Viewer is once again executed on the computer the computer-executable instructions on the portable computer readable medium 12 can be executed by the computer's central processing unit to cause recognition that such temporary files exist on the computer. The computer then deletes the medical output not saved to a non-volatile memory upon being reactivated following the interruption event. After viewing the decrypted medical output, however, the user has the option to save the decrypted medical output to a desired location on the computer-accessible memory that is not temporary. Decrypted medical output saved on the computer-accessible memory at a location that is not temporary will not be automatically deleted following an interruption event experienced by the computer.

The window 132 shown in FIG. 8 also has a “Help” button 207, along with a preliminary warning 209 to the user that unlocking the portable computer readable medium 12 will store medical output on the computer being used in an attempt to view the medical output. The preliminary warning 209 also instructs the user to select the Help button 207 to obtain additional information about how the medical output will be processed.

Upon selecting the Help button 207, a window 212 such as that shown in FIG. 10 can be displayed by the computer to the user. The window 212, which can optionally include the contents of the Readme file discussed above, explains that the decryption utility executable from the portable computer readable medium 12 for decrypting the medical output can temporarily save at least portions of the decrypted medical output on the computer-accessible memory in communication with the computer. Further, the decryption utility, responsive to sensing that both the portable computer readable medium 12 has been removed from the computer and the Viewer presenting the medical output to the user has been closed, will delete any such temporarily stored medical output from the computer-accessible memory. If one, but not both of these conditions is met then the temporarily stored medical output can optionally remain on the computer.

The amount of medical output that must first be decrypted before being presented by the computer to the end user can depend on the type of encryption used. For example, if 7Zip is used for the encryption, all encrypted medical output must be decrypted and stored at least temporarily on the computer before the user can be presented with any portion of the decrypted medical output. In contrast, using TrueCrypt for encryption allows the user to view a preview of the contents of the portable computer readable medium 12 in a decrypted state, and from there select the portion, which is optionally less than all, of the medical output the user desires to view. The selected portion of the medical output can be decrypted, at least temporarily saved at the temporary memory location of the computer-accessible memory and viewed before all of the encrypted medical output on the portable computer readable medium 12 is decrypted.

Further, in many instances more than a single portable computer readable medium 12 will be required to store the entire amount of medical output to be delivered to the end user via the portable computer readable medium 12. The medical output can, under such circumstances be divided and stored on a plurality of portable computer readable media 12. Each of the portable computer readable media 12 in the series is to be individually encrypted independent of encryption of medical output on other portable computer readable media 12 in the series, in a manner allowing the user to decrypt and be presented with the medical output stored on each portable computer readable medium 12 in any order. Thus, the medical output on each portable computer readable medium 12 can be decrypted in sequence (i.e., disc 1, disc 2, disc 3, . . . disc N), and out of sequence (i.e., disc 3, disc 1, disc N, . . . disc 2). Further, any single portable computer readable medium 12 in the series, or any combination of the portable computer readable media 12 in the series can be loaded into the computer by the end user and the medical output thereon viewed/extracted individually, independent of the other portable computer readable media 12. In other words, if the user wishes only to view or otherwise review the medical output on disc 2 without viewing the medical output stored on any other portable computer readable medium 12 such as disc 1, the user can decrypt the medical output on disc 2, launch the Viewer and view or otherwise observe that medical output independent of disc 1 (i.e., without first decrypting and saving or extracting the medical output from disc 1).

According to alternate embodiments, an evaluation utility can also be included on the portable computer readable medium 12 to be executed for determining whether the computer-accessible memory of the computer used to view the medical output has enough free space to store the decrypted medical output. When the user elects to simply view the medical output (i.e., by selecting the View button 137 discussed above), the evaluation utility can determine whether the temporary memory location to be used to temporarily store the decrypted medical output is large enough for this purpose. Similarly, when the user elects to extract and save the decrypted medical output (i.e., by selecting the Extract button 136 discussed above), the evaluation utility can determine whether the memory location selected by the user to save the decrypted medical output is large enough to store the selected medical output. For either embodiment, if the available memory location is not large enough to store the medical output to be decrypted, the evaluation utility, when executed, can recommend to the user that additional memory is needed, and how much additional memory is needed before beginning decryption of the medical output, and prompt the user to clear the required memory locations needed before the decryption process begins. The evaluation utility can avoid: 1) wasting the user's time in a decryption process that is not going to complete, and 2) avoiding filling the hard drive in such a way as to render it useless or severely compromised in certain circumstances.

As used herein, the term component can include computer hardware, computer-executable instructions stored on a non-volatile computer memory to be executed by a computer processor, or a combination thereof to perform the various method steps described herein in the securing of medical output.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of protecting medical output to be stored on a portable computer-readable medium, the method comprising:
using a computer operatively connected to a communication network, receiving the medical output to be stored on the portable computer-readable medium over the communication network;
restricting access to the medical output and establishing a key that is to be entered by an intended recipient of the portable computer-readable medium into a user computer to gain access to the medical output stored on the portable computer-readable medium;
assigning an identifier to the portable computer-readable medium and storing the identifier on both the portable computer-readable medium and a computer memory operatively connected to the computer;
storing the medical output on the portable computer-readable memory, wherein access to the medical output on the portable computer-readable medium is restricted, requiring the key to access and view the medical output;
storing the key in the computer memory and establishing a relationship associating the identifier with the key to enable identification of the key with knowledge of the identifier; and
storing a security utility and a medical presentation utility that is compatible with the medical output on the portable computer-readable medium, wherein the security utility is executable by the user computer to grant access to the medical output on the portable computer-readable medium in response to entry of the key and the medical presentation utility is executable by the user computer to present the medical output to the intended recipient of the portable computer-readable medium subsequent to entry of the key into the security utility.

2. The method according to claim 1 further comprising
using the computer, storing the medical output on the portable computer-readable medium in an encrypted format, wherein the security utility is a decryption utility that is executable by the user computer to decrypt the medical output in response to entry of the key.

3. The method according to claim 1, wherein the key comprises a password that is randomly generated by the computer and automatically stored in the computer memory in association with the identifier.

4. The method according to claim 1, wherein the medical presentation utility comprises:
a preview component that is executable by the user computer to retrieve a portion of the medical output from the portable computer-readable medium and present the portion retrieved to the user and temporarily store the portion of the medical output presented on a default memory location of a computer-accessible memory of the user computer, and
an extraction component that is executable by the user computer to save at least a portion of the medical output at a user-selectable memory location of the computer-accessible memory of the user computer from where it can be subsequently accessed and presented to the user in a human-readable format without the portable computer-readable medium.

5. The method according to claim 1, wherein the medical output is to be stored on a plurality of portable computer-readable media and storing the medical presentation utility comprises independently storing the medical presentation utility on each of the plurality of portable computer-readable media for presenting at least a portion of the medical output on each of the plurality of portable computer-readable media to the intended recipient independently of medical output stored on another of the plurality of portable computer-readable medium.

6. The method according to claim 1, wherein the key comprises a password formed from a plurality of characters included on a label provided to the portable computer-readable medium, wherein the plurality of characters forming the password are included in label content provided to the label to convey information other than the password and are not identified as the password on the label.

7. The method according to claim 4 further comprising automatically deleting the at least a portion of the medical output temporarily stored at the default memory location on the computer-accessible memory of the user computer in response to at least one of:
removal of the portable computer-readable medium from the user computer, and
closing of the viewer operating on the user computer to present the portion of the medical output to the intended recipient.

8. The method according to claim 1 further comprising storing a human-readable file on the portable computer-readable medium, wherein the human-readable file is accessible via the user computer without entry of the key and comprises the identifier and contact information for a party with access to the key stored in the computer memory that the intended recipient can contact and present with the identifier to determine the identifier in response.

9. The method according to claim I further comprising automatically generating an electronic communication comprising the key and transmitting the electronic communication to the intended recipient to deliver the key separately from the portable computer-readable medium.

10. The method according to claim 9, wherein the key is not delivered in a fixed medium of expression with the portable computer-readable medium when the portable computer-readable medium is delivered to the intended recipient.

11. The method according to claim 1, wherein establishing the key comprises selecting a plurality of characters to be included in fixed label content of a label for the portable computer-readable medium to be assembled into a password.

12. The method according to claim 1, wherein a label for the portable computer-readable medium comprises a visual indicator indicating a type of encryption employed to restrict access to the medical output stored on the portable computer-readable medium.

13. The method according to claim 1, wherein the identifier comprises a unique ID number assigned to the portable computer-readable medium.

14. The method according to claim 1, wherein the portable computer-readable medium comprises at least one of an optical medium and a flash memory medium.

15. The method according to claim 1 further comprising automatically generating a physical communication comprising the key, the physical communication to be delivered by courier to a mailing address of the intended recipient separately from the portable computer-readable medium.

16. A publisher for publishing a portable computer-readable medium storing encrypted medical output, the publisher comprising:
a network interface for receiving the medical output over a communication network;
a computer-accessible memory for at least temporarily storing the medical output received over the communication network;
a recording bay for receiving the portable computer-readable medium and writing the medical output to the portable computer-readable medium;
a labeler for creating label content to be associated with the portable computer-readable medium; and
a processing component for executing computer-executable instructions stored in the computer-executable memory for performing a method comprising:
restricting access to the medical output and establishing a key that is to be entered by an intended recipient of the portable computer-readable medium into a user computer to gain access to the medical output stored on the portable computer-readable medium
assigning an identifier to the portable computer-readable medium and storing the identifier on both the portable computer-readable medium and a computer memory operatively connected to the publisher;
storing the medical output on the portable computer-readable memory via the recording bay, wherein access to the medical output on the portable computer-readable medium is restricted, requiring the key to access and view the medical output;
storing the key in the computer memory and establishing a relationship associating the identifier with the key to enable identification of the key with knowledge of the identifier; and
storing a security utility and a medical presentation utility that is compatible with the medical output on the portable computer-readable medium, wherein the security utility is executable by the user computer to grant access to the medical output on the portable computer-readable medium in response to entry of the key and the medical presentation utility is executable by the user computer to present the medical output to the intended recipient of the portable computer-readable medium subsequent to entry of the key into the security utility.

17. The publisher according to claim 16 further comprising an email component that is operable to automatically generate an electronic communication comprising the key and transmit the electronic communication to the intended recipient to deliver the key separately from the portable computer-readable medium.

18. The publisher according to claim 16 further comprising a mailing component that is operable to automatically generate a physical communication comprising the key to be delivered by courier to a mailing address of the intended recipient separately from the portable computer-readable medium.

19. The publisher according to claim 16, wherein the processing component comprises a random password generator for randomly generating a password as the key to be saved in association with the identifier.

20. The publisher according to claim 17, wherein the email component is operable to include an identification of the identifier in the electronic communication comprising the key that is transmitted to the intended recipient.
